(19) United States
(12) Patent Application Publication
(10) Pub. No.: US 2020/0348485 A1
(43) Pub. Date: Nov. 5, 2020

(54) CAMERA LENS ASSEMBLY

(71) Applicant: SAMYANG OPTICS CO., LTD, Changwon-si, Gyeongsangnam-do (KR)

(72) Inventor: Han Jea LEE, Changwon-si (KR)

(73) Assignee: SAMYANG OPTICS CO., LTD, Changwon-si, Gyeongsangnam-do (KR)

(21) Appl. No.: 16/759,250

(22) PCT Filed: Dec. 6, 2017
(86) PCT No.: PCT/KR2017/014222

§ 371 Date: Apr. 24, 2020

(30) Foreign Application Priority Data
Oct. 27, 2017 (KR) 10-2017-0140799

(51) Int. Cl. G02B 7/09; G03B 13/36

(52) U.S. Cl. CPC G02B 7/09; G03B 13/36

(57) ABSTRACT

The present invention relates to a camera lens assembly having a structure using a plurality of focusing units. The lens holder according to the embodiment of the present invention includes a first fastening unit to which any one focusing unit of the plurality of focusing units is fastened, a second fastening unit to which the other focusing unit of the plurality of focusing units is fastened, a first guide bar fastening groove configured to protrude from the lens holder to determine a position of the lens, and a second guide bar fastening groove configured to horizontally maintain the lens and prevent rotation of the lens.

### TECHNICAL FIELD

The present invention relates to a camera lens assembly, and more specifically, to a camera lens assembly having a structure using a plurality of focusing motors.

### BACKGROUND ART

Conventionally, one focusing motor has been used for a camera lens assembly, and a linear ultrasonic motor is mainly used as the focusing motor. Therefore, since a weight of the lens is applied to only one focusing motor, there is a problem in that a heavy lens cannot be moved when the lens is moved to adjust a focus thereof.

A ring-type motor should be used for a heavy lens rather than a linear ultrasonic motor, but the ring-type motor is expensive, and thus there is a problem of an increase in manufacturing costs for a camera lens.

A DC motor may be used as another type of motor for a heavy lens and, in this case, when the DC motor is used, a volume of a camera lens assembly should be increased, or a gear box should be additionally installed in the camera lens assembly. Therefore, a weight of the whole camera assembly is increased, and noise is increased when a focus of a lens is adjusted, and thus user inconvenience may be caused.

Therefore, there is a need for a design for a camera lens assembly structure that allows a heavy lens to be used for a long period of time and has excellent durability while using a relatively inexpensive linear ultrasonic motor.

(PATENT DOCUMENT 1) Korean patent Registration No. 10-2014-0144126

### DISCLOSURE OF INVENTION

### Technical Problem

The present invention is directed to providing a camera lens assembly having a structure using a plurality of focusing motors.

The present invention is directed to providing a camera lens assembly which allows a heavy lens group to be moved as in the case of using an expensive focusing motor even when a lens is moved using a relatively inexpensive linear ultrasonic motor.

The scope of the present invention is not limited to the above-described objects, and other unmentioned objects can be clearly understood by those skilled in the art from the following descriptions.

### Solution to Problem

The present invention is directed to providing a camera lens assembly which includes a plurality of focusing units configured to allow a lens to reciprocate in an optical axis direction and a lens holder fastened to the plurality of focusing units and configured to reciprocate in the optical axis direction.

The lens holder may include a first fastening unit fastened to any one focusing unit of the plurality of focusing units, a second fastening unit to which the other focusing unit of the plurality of focusing units is inserted, a first guide bar fastening groove configured to protrude from the lens holder to determine a position of the lens, and a second guide bar insertion groove configured to horizontally maintain the lens and prevent rotation of the lens.

The first fastening unit and the second fastening unit according to the embodiment of the present invention may form an angle of 90° to 270°? from the center of the lens holder.

The camera lens assembly may further include a controller configured to control the focusing units, wherein the controller may transmit a control signal to all the plurality of focusing units using a feedback signal received from a position sensor so as to allow the plurality of focusing units to simultaneously reciprocate in the optical axis direction and the lens to be moved by torques combined by reciprocation of the plurality of focusing units.

The camera lens assembly may move the lens by combining torques caused by reciprocation of the plurality of focusing units being combined.

The controller may adjust a position so that a center of a slide sub unit is positioned to be collinear in the optical axis direction by detecting a position of each of the slide sub units constituting the plurality of focusing units.

The camera lens assembly further may include a cover configured to accommodate the lens and including a plurality of holes to which the plurality of focusing units are fastened, and a barrel unit configured to accommodate the lens holder and including a plurality of guide bar fastening grooves into which the first guide bar inserted into the first guide bar fastening groove and the second guide bar inserted into the second guide bar fastening groove are inserted.

### Advantageous Effects of Invention

A camera lens assembly according to an embodiment of the present invention allows a heavier lens than a lens driven using one linear ultrasonic motor to be driven.

A camera lens assembly using a plurality of linear ultrasonic motors according to an embodiment of the present invention can have more increased durability than a camera lens assembly using one linear ultrasonic motor.

### BRIEF DESCRIPTION OF DRAWINGS

FIG. 1 is a perspective view of a camera lens assembly according to an embodiment of the present invention.

FIG. 2 is an exploded view of the camera lens assembly according to the embodiment of the present invention.

FIG. 3A is a perspective view showing a cover and components connected to the cover according to an embodiment of the present invention, and FIG. 3B is an exploded view of the portion shown in FIG. 3A.

FIG. 4 is a cross-sectional view of the camera lens assembly according to the embodiment of the present invention.

FIG. 5 is a view showing a lens holder according to an embodiment of the present invention.

FIG. 6A is a perspective view of a focusing unit according to an embodiment of the present invention, FIG. 6B is an exploded view of the focusing unit, and FIG. 6C is a perspective view of a slide sub-unit which is a sub-component of the focusing unit according to the embodiment of the present invention.

### MODE FOR THE INVENTION

Hereinafter, exemplary embodiments of the present invention will be described in detail with reference to the accompanying drawings. Advantages and features of the present invention and methods of achieving the same will be clearly understood with reference to the accompanying drawings and the following detailed embodiments. However, the present invention is not limited to the embodiments to be disclosed, and may be implemented in various different forms. The embodiments are provided in order to fully explain the present invention and fully explain the scope of the present invention for those skilled in the art. The scope of the present invention is defined by the appended claims. Terms used herein will be briefly described and the present invention will be described in detail. Like reference numerals refer to like elements throughout the specification.

Unless otherwise defined, all of the terms (including technical and scientific terms) used herein have the same meaning as commonly understood by one of ordinary skill in the art to which the present invention belongs. In addition, the terms that are generally used and also defined in commonly used dictionaries are not interpreted ideally or excessively unless the terms have been clearly and specifically defined.

In the description, a singular expression may include a plural expression unless otherwise specified. It will be further understood that the terms “comprises,” “includes,” and/or “having,” when used in this specification, specify the presence of stated elements, steps, operations, and/or components, but do not preclude the presence or addition of one or more other elements, steps, operations, and/or components.

When it is determined that detailed description of known techniques involved in the present invention obscures the gist of the present invention, the detailed description thereof will not be made.

Further, the terms described below are defined in consideration of the functions in the embodiment of the present invention and may be changed according to user/operator's intention or custom. Therefore, the terms will be more clearly defined according to descriptions of various embodiments of the present invention.

In descriptions of the embodiments of the present invention, the terms “first,” “second,” etc. are used herein to distinguish one element from, and the order of the terms may be arbitrarily determined.

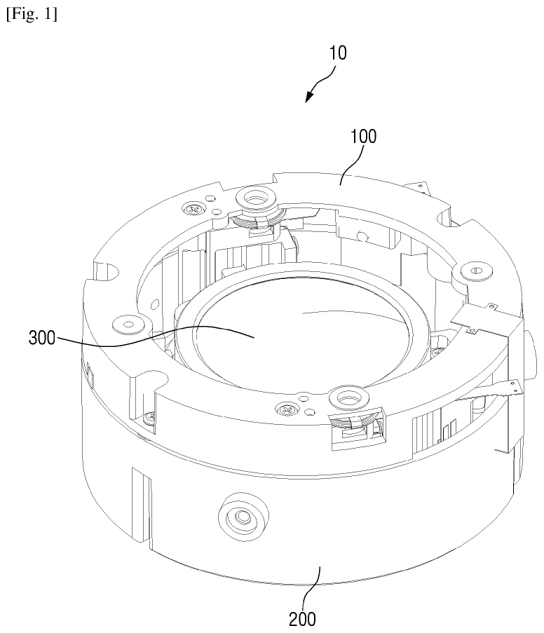

FIG. 1 is a perspective view of a camera lens assembly according to an embodiment of the present invention.

A camera lens assembly 10 according to the embodiment of the present invention servers to accommodate a camera lens 300 and to adjust a focus of the camera lens 300. Referring to FIG. 1, the camera lens assembly 10 according to the embodiment of the present invention may include a cover 100 for accommodating the camera lens 300 and a barrel unit 200 for accommodating the camera lens 300 and components configured to adjust the focus of the camera lens.

However, the camera lens assembly according to the embodiment of the present invention may not necessarily include the camera lens 300.

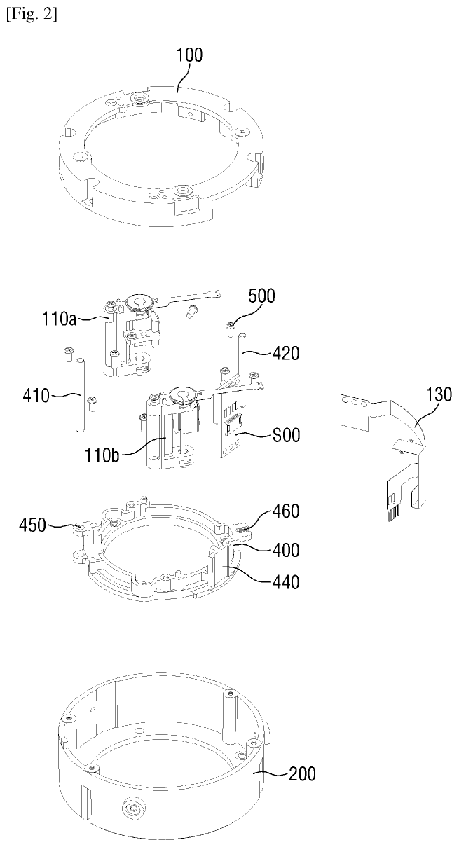

FIG. 2 is a detailed and exploded view of the camera lens assembly shown in FIG. 1.

Referring to FIG. 2, the camera lens assembly according to the embodiment of the present invention may include a cover 100, a first focusing unit 110a and a second focusing unit 110b included in a plurality of focusing units, a controller 120 controlling motors of the focusing units, a flexible printed circuit board (FPCB) 130 for transmitting a control signal generated by the controller 120 to the motors, a lens holder 400, a barrel unit 200 coupled to the cover 100 to accommodate the components, and a first guide bar 410 and a second guide bar 420 inserted into the barrel unit 200 and the lens holder 400.

Although two focusing units are shown in the embodiment of the present invention, at least three focusing units may be included in the embodiment of the present invention.

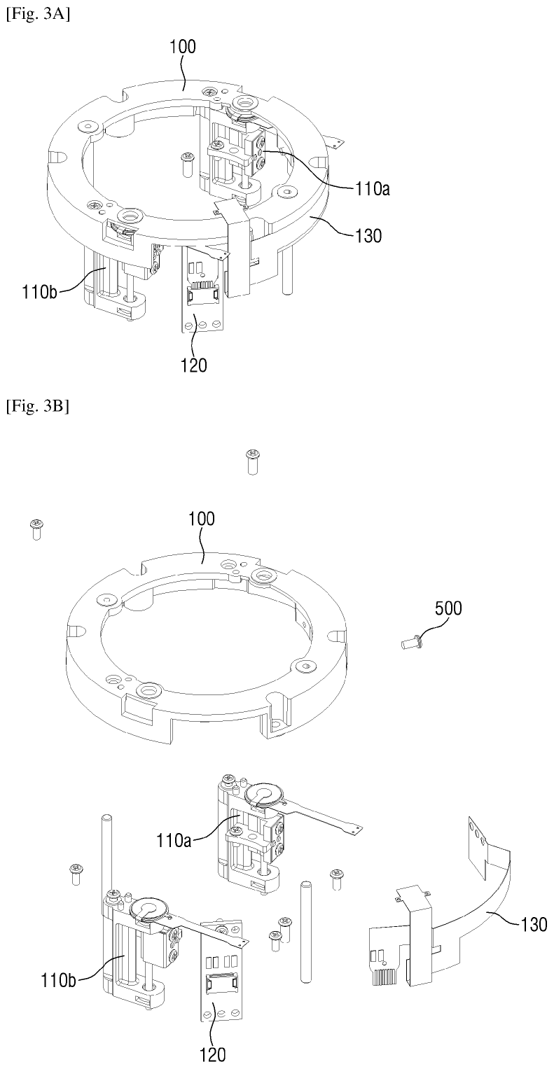

FIG. 3A is a perspective view showing a cover according to the embodiment of the present invention and a component connected to the cover, and FIG. 3B is an exploded view of the portion shown in FIG. 3A.

Referring to FIGS. 3A and 3B, the plurality of focusing units 110, the controller 120, and the FPCB 130 may be coupled to the cover 100 according to the embodiment of the present invention and may be coupled by four screws.

The camera lens assembly according to the embodiment of the present invention includes a motor for driving the plurality of focusing units 110, and a linear ultrasonic motor may be used in the embodiment of the present invention.

When the controller 120 according to the embodiment of the present invention generates a driving signal for driving the linear ultrasonic motor, the driving signal is transmitted to the focusing units 110 through the FPCB 130, and thus a slide sub unit 160 included in the focusing units 110 may reciprocate in an optical axis direction perpendicular to the lens.

The controller 120 according to the embodiment of the present invention simultaneously drives the plurality of linear ultrasonic motors by transmitting the driving signal to both the first focusing unit 110a and the second focusing unit 110b.

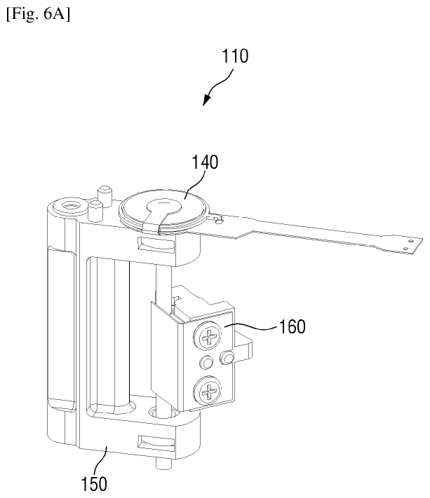

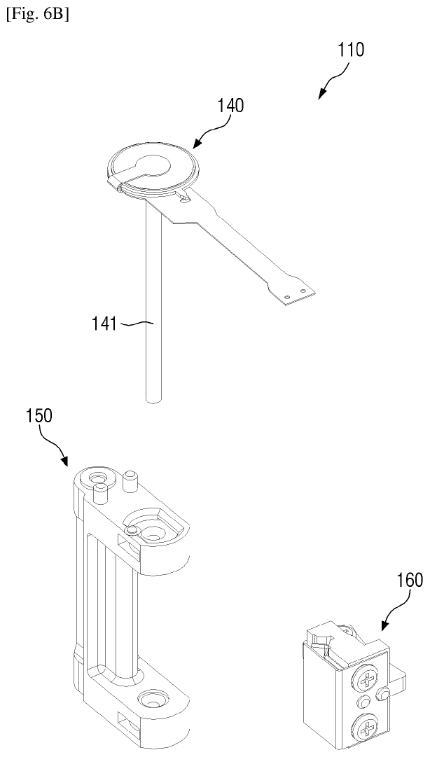

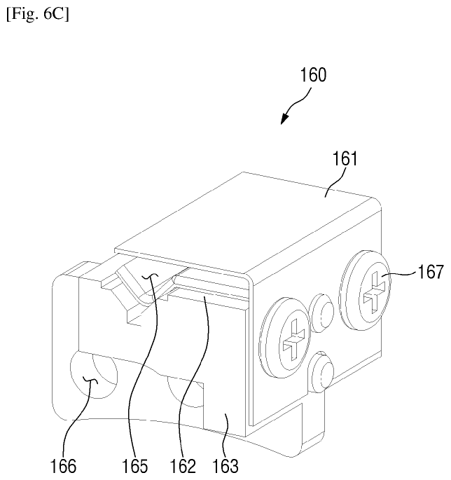

Meanwhile, the slide sub unit according to the embodiment of the present invention will be described in detail in FIG. 6.

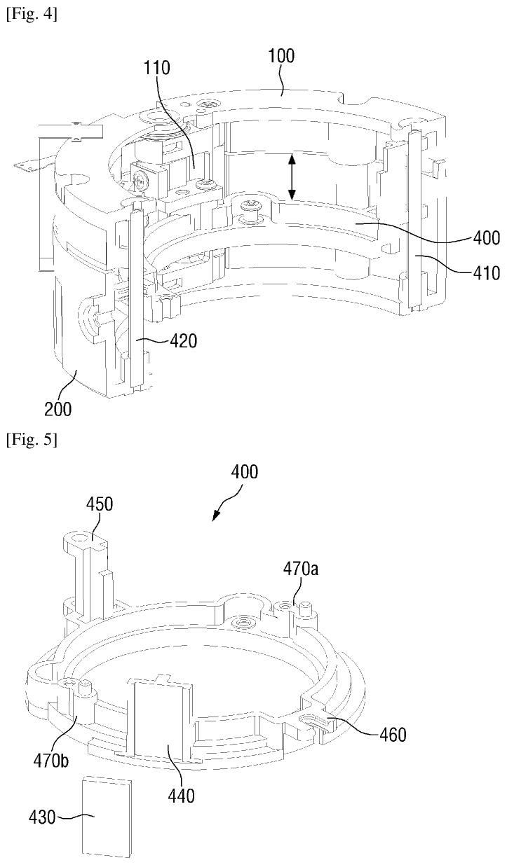

FIG. 4 is a cross-sectional view of the camera lens assembly according to the embodiment of the present invention.

Referring to FIG. 4, as the slide sub unit 160 of the focusing units 110 reciprocates, the lens holder 400 coupled to the slide sub unit 160 is vertically moved with respect to the axes of the first guide bar 410 and the second guide bar 420.

According to an embodiment of the present invention, torques caused by reciprocation of the plurality of focusing units 110 are combined, and thus the lens provided in the lens holder 400 may be moved. That is, the torque caused by the first focusing unit 110a and the torque caused by the second focusing unit 110b are combined, and thus the lens and the lens holder 400 may be moved.

Therefore, since a load being applied to the linear ultrasonic motor is dispersed to the plurality of linear ultrasonic motors, a heavier lens may be mounted in the camera lens assembly according to the embodiment of the present invention, and the linear ultrasonic motors may be used longer.

FIG. 5 is a view showing a lens holder according to the embodiment of the present invention.

The lens holder according to the embodiment of the present invention may include a first fastening unit 470a to which the first focusing unit 110a of the plurality of focusing units is fastened and a second fastening unit 470b to which the second focusing unit 110b which is the other one of the plurality of focusing units is fastened.

The lens holder 400 according to the embodiment of the present invention may further include a first guide bar fastening groove 450 protruding from the lens holder to additionally position the lens and a second guide bar fastening groove 460 formed to horizontally maintain the lens and prevent rotation thereof.

The first guide bar 410 according to the embodiment of the present invention is inserted into the first guide bar fastening groove 450, and the first guide bar fastening groove 450 may include two holes to determine a position of the lens fixed to the lens holder.

The second guide bar 420 according to the embodiment of the present invention is inserted into the second guide bar fastening groove 460, and the second guide bar fastening groove 460 may have a protruding portion having a partially open portion to horizontally maintain the lens and prevent rotation thereof.

Further, the first guide bar 410 and second guide bar 420 are inserted into a plurality of guide bar insertion grooves provided in the barrel unit 200, and thus the horizontally maintaining of the lens and the prevention of the rotation thereof may be more effectively performed when the lens holder 400 reciprocates in the optical axis direction.

The first fastening unit 470a and the second fastening unit 470b according to the embodiment of the present invention may form an angle of 90° to 270° from the center of the lens holder 400. The angle between the first fastening unit 470a and the second fastening unit 470b is determined so that the torque generated by the focusing units 110 is maximally generated.

The lens holder 400 according to the embodiment of the present invention may further include a magnetic fastening unit 440 to which a magnetic body 430 may be coupled, and the magnetic body 430 measures a position of the lens holder 400 according to the embodiment of the present invention to allow the controller 120 to control the movement of the focusing units 110.

More specifically, a magnetic field is changed as the magnetic body 430 fastened to the lens holder 400 reciprocates with the lens holder 400, and the controller 120 according to the embodiment of the present invention may include a position sensor detecting a change in the magnetic field. Therefore, according to the embodiment of the present invention, the magnetic body 430 may be positioned at a position facing the controller 120.

Meanwhile, although a high resolution magnetic linear encoder is used as the position sensor according to the embodiment of the present invention, the position sensor is not limited to a magnetic field change sensor, and a conventional position sensor, such as a resistive position sensor, a reflective photo interrupter, an optical position sensor, a Hall effect sensor, and a laser displacement sensor, may be adopted.

According to the embodiment of the present invention, the controller 120 transmits the control signal using a feedback signal, which is received from the position sensor, to all the plurality of focusing units so as to simultaneously control the plurality of focusing units 110, and the controller may allow the focusing units to simultaneously reciprocate in the optical axis direction.

That is, in other words, the controller 120 may simultaneously control the movement of the first focusing unit 110a and the second focusing unit 110b.

Further, the controller according to the embodiment of the present invention may adjust a position so that the center of each of the slide sub units is positioned to be collinear on the guide bar or in the optical axis direction by detecting a position of the each of the slide sub units constituting the plurality of focusing units.

Therefore, the camera lens assembly according to the embodiment of the present invention may maximally generate torques combined by the first focusing unit and the second focusing unit.

FIG. 6A is a perspective view of a focusing unit according to the embodiment of the present invention, FIG. 6B is an exploded view of the focusing unit, and FIG. 6C is a perspective view of a slide sub-unit which is a sub-component of the focusing unit according to the embodiment of the present invention.

The focusing unit 110 according to the embodiment of the present invention may include a linear ultrasonic motor 141, a slide bar 142, and a slide frame 150, and the slide sub unit 160.

According to the embodiment of the present invention, when the linear ultrasonic motor 141 generates vibration, the vibration is transmitted to the slide bar 142, and thus the slide bar 142 vibrates. Therefore, since the slide sub unit 160 may be vertically moved with respect to an axis of the slide bar 142 by the vibration of the slide bar 142, the lens holder 400 coupled to the slide sub unit 160 may reciprocate in the optical axis direction.

Meanwhile, referring to FIG. 6C, the slide sub unit 160 may include a plate-spring 161 forming an exterior of the slide sub unit 160, a V-shaped block 162 having a V-shaped groove 165 formed between the plate-spring 161 and a slide main unit 163, and the slide main unit 163 having a hole 166 for fastening the lens holder 400. The plate-spring 161 may be connected to the slide main unit 163 by a screw 167.

According to an embodiment of the present invention, the slide main unit 163 may be moved axially along the slide bar 142 while the slide bar 142 is inserted into the V-shaped groove 165.

Further, the screw is connected to pass through the hole 166 formed in the slide main unit 163 and the fastening unit 470 of the lens holder 400, and thus the slide sub unit 160 and the lens holder 400 may be coupled to each other.

Meanwhile, the related art may be adopted as a method of driving the focusing units, and a description of a configuration easily understood by the related art will be omitted.

It will be understood by those skilled in the art that various changes may be made without departing from the spirit and scope of the present invention. Therefore, the disclosed methods should be considered in a descriptive sense only and not for the purpose of limitation. Therefore, the scope of the present invention is defined not by the detailed description of the present invention but by the appended claims, and all differences within the scope will be construed as being included in the present invention.

1. A camera lens assembly comprising:
a plurality of focusing units configured to allow a lens to reciprocate in an optical axis direction; and
a lens holder fastened to the plurality of focusing units and configured to reciprocate in the optical axis direction,
wherein the lens holder includes:
a first fastening unit fastened to any one focusing unit of the plurality of focusing units;
a second fastening unit to which the other focusing unit of the plurality of focusing units is fastened;
a first guide bar fastening groove configured to protrude from the lens holder to determine a position of the lens; and
a second guide bar insertion groove configured to horizontally maintain the lens and prevent rotation of the lens.

2. The camera lens assembly of claim 1, wherein the first and second fastening units form an angle of 90° to 270° from a center of the lens holder.

3. The camera lens assembly of claim 1, further comprising a controller configured to control the focusing units,
wherein the controller transmits a control signal to all the plurality of focusing units using a feedback signal received from a position sensor so as to allow the plurality of focusing units to simultaneously reciprocate in the optical axis direction and the lens to be moved by torques combined by reciprocation of the plurality of focusing units.

4. The camera lens assembly of claim 3, wherein the controller is configured to adjust a position so that a center of a slide sub unit is positioned to be collinear in the optical axis direction by detecting a position of each slide sub unit constituting the plurality of focusing units.

5. The camera lens assembly of claim 1, further comprising:
a cover configured to accommodate the lens and including a plurality of holes to which the plurality of focusing units are fastened; and
a barrel unit configured to accommodate the lens holder and including a plurality of guide bar insertion grooves into which the first guide bar inserted into the first guide bar fastening groove and the second guide bar inserted into the second guide bar fastening groove are inserted.
